(19) United States
(12) Patent Application Publication
(10) Pub. No.: US 2016/0112883 A1
(43) Pub. Date: Apr. 21, 2016

(54) Wireless Signal Quality Indicator

(71) Applicant: Microsoft Corporation, Redmond, WA (US)

(72) Inventors: Amer A. Hassan, Kirkland, WA (US); Andrei Jefremov, Jarfalla (SE)

(21) Appl. No.: 14/517,273

(22) Filed: Oct. 17, 2014

(51) Int. Cl. H04W 24/02; H04L 1/00

(52) U.S. Cl. CPC H04W 24/02; H04L 1/004

(57) ABSTRACT

Techniques for wireless signal quality indicator are described. According to various implementations, various attributes of a wireless signal are detected. Attributes of the wireless signal are processed to ascertain a quality of the wireless signal. Based on an ascertained signal quality, indicia of the signal quality can be exposed.

### BACKGROUND

Many devices today utilize some form of wireless data communication. While a variety of different types of wireless data communication exist, radio frequency (RF) communication is pervasive. Examples of RF communication include wireless cellular networks (e.g., for cell phones), broadband wireless (e.g., Wi-Fi®), broadcast television, global positioning system (GPS) navigation, and so forth.

Wireless data communication can be particularly useful in networking scenarios. For instance, a computing device can connect to a network, such as the Internet, via a wireless access point. Signal quality variations may occur, however, based on different network-related conditions that occur beyond a local access point. Enabling signal quality to be surfaced to users and other entities presents a number of challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for wireless signal quality indicator are described. According to various implementations, various attributes of a wireless signal are detected. Attributes of the wireless signal are processed to ascertain a quality of the wireless signal. Based on an ascertained signal quality, indicia of the signal quality can be exposed.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more embodiments.

FIG. 2 illustrates an example implementation scenario for techniques for wireless signal quality indicators in accordance with one or more embodiments.

FIG. 3 illustrates an example implementation scenario for wireless signal quality indicators in accordance with one or more embodiments.

FIG. 4 is a flow diagram that describes steps in a method for outputting a wireless signal quality indicator in accordance with one or more embodiments.

FIG. 5 is a flow diagram that describes steps in a method for generating a signal quality indicator based on errors detected in wireless signal in accordance with one or more embodiments.

FIG. 6 is a flow diagram that describes steps in a method for characterizing wireless signal quality based on errors detected in wireless signal in accordance with one or more embodiments.

FIG. 7 is a flow diagram that describes steps in a method for determining an adjustment value for adjusting a signal quality indicator in accordance with one or more embodiments.

FIG. 8 is a flow diagram that describes steps in a method for presenting indicia of signal strength and signal quality in accordance with one or more embodiments.

FIG. 9 is a flow diagram that describes steps in a method for characterizing errors in wireless data in accordance with one or more embodiments.

FIG. 10 is a flow diagram that describes steps in a method for characterizing errors in wireless data in accordance with one or more embodiments.

FIG. 11 is a flow diagram that describes steps in a method for characterizing errors in data transmission in wireless data in accordance with one or more embodiments.

FIG. 12 is a flow diagram that describes steps in a method for characterizing download signal quality and upload signal quality of a wireless signal in accordance with one or more embodiments.

FIG. 13 illustrates an example signal strength indicator in accordance with one or more embodiments.

FIG. 14 illustrates an example signal quality indicator in accordance with one or more embodiments.

FIG. 15 illustrates an example signal attributes indicator in accordance with one or more embodiments.

FIG. 16 illustrates an example signal quality indicator in accordance with one or more embodiments.

FIG. 17 illustrates an example system and computing device as described with reference to FIG. 1, which are configured to implement embodiments of techniques described herein.

### DETAILED DESCRIPTION

### Overview

Techniques for wireless signal quality indicator are described. According to various implementations, various attributes of a wireless signal are detected. The wireless signal, for instance, represents a wireless signal communicated between a wireless base station and a wireless device, such as a wireless client device. Example attributes of a wireless signal include signal strength (e.g., a Received Signal Strength Indicator (RSSI)), errors detected in data transmitted in the wireless signal, data transmission bandwidth over the wireless signal, and so forth.

According to various implementations, attributes of the wireless signal are processed to ascertain a quality of the wireless signal. Generally, signal quality provides an indicator of a level of fidelity with which a wireless signal transmits data, e.g., with reference to errors detected in wireless data. Based on an ascertained signal quality, indicia of the signal quality can be exposed. For instance, a graphical signal quality indicator can be displayed that provides a visual indicator of signal quality. In at least some implementations, a signal strength indicator is adjusted to reflect a signal quality of a representative signal.

According to one or more implementations, wireless signal can have high signal strength, e.g., a high received signal strength indicator (RSSI). The wireless signal, however, may include multiple data errors, such as flipped bits, omitted bits, inserted bits, and so on. Thus, a signal strength indicator for the wireless signal at the particular location can be adjusted (e.g., reduced) based on the presence of the multiple data errors. For instance, an indication of signal strength can be adjusted downward to indicate that while the signal strength may be high, the number of data errors is also high.

In the following discussion, an example environment is first described that is operable to employ techniques described herein. Next, a section entitled “Example Implementation Scenarios” describes some implementation scenarios involving techniques discussed herein which may be employed in the example environment as well as in other environments. Following this, a section entitled “Example Procedures” describes some example methods in accordance with one or more implementations. Next, a section entitled “Graphical Indicators of Signal Attributes” describes some example graphical indicators of signal attributes in accordance with one or more implementations. Finally, a section entitled “Example System and Device” describes an example system and device that are operable to employ techniques discussed herein in accordance with one or more embodiments.

### Example Environment

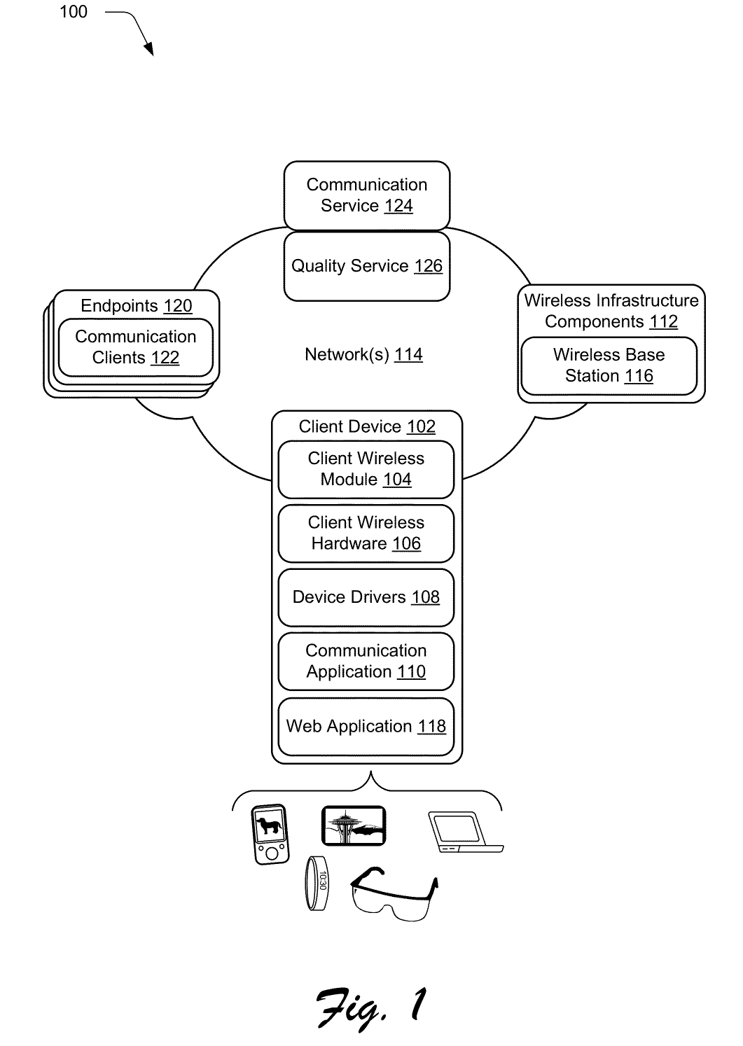

FIG. 1 is an illustration of an environment 100 in an example implementation that is operable to employ techniques for wireless signal quality indicator in accordance with one or more implementations. Generally, wireless signal quality pertains to various quality indicators for wireless data communication, such as wireless broadband data, cellular data, and so forth. Environment 100 includes a client device 102 which can be embodied as any suitable device such as, by way of example and not limitation, a smartphone, a tablet computer, a wearable computing device, a portable computer (e.g., a laptop), a desktop computer, and so forth. One of a variety of different examples of a client device 102 is shown and described below in FIG. 17.

The client device 102 of FIG. 1 is illustrated as including a client wireless module 104, which is representative of functionality to enable the client device 102 to communicate wirelessly with other devices and/or entities. The client wireless module 104 is configured to enable data communication via one or more of a variety of different wireless techniques and protocols. Examples of such techniques and/or protocols include wireless cellular communications (e.g. 3G, 4G, Long Term Evolution (LTE), and so forth), near field communication (NFC), short-range wireless connections (e.g., Bluetooth), local area wireless networks (e.g., one or more standards in compliance with IEEE 802.11), wide area wireless networks (e.g., one or more standard in compliance with IEEE 802.16 or 802.22), wireless telephone networks, and so on.

The client device 102 further includes client wireless hardware 106, which is representative of various hardware components that can be employed to enable the client device 102 to communicate wirelessly. Examples of the client wireless hardware 106 include radio transmitters, radio receivers, various types and/or combinations of antennas, impedance matching functionality, and so on. In at least some embodiments, the client device 102 is a multi-radio device that can communicate via different wireless technologies and/or protocols. For instance, the client wireless hardware 106 may include multiple antennas that are individually configured for different wireless technologies. The client wireless hardware 106, for example, may include a first antenna configured for cellular communications (e.g., Long-Term Evolution (LTE), 5G, and so forth), and a second antenna that is configured for wireless broadband, e.g., WiFi®.

Further included as part of the client device 102 are one or more device drivers 108, which are representative of functionality to enable the client device 102 to interact with various devices, and vice-versa. For instance, the device drivers 108 can enable interaction between various functionalities of the client device 102 (e.g., an operating system, applications, services, and so on) and different devices of the client device 102, such as input/output (I/O) devices. The device drivers 108, for instance, can enable interaction between the client wireless module 104 and the client wireless hardware 106 to enable the client device 102 to transmit and receive wireless signals.

In at least some embodiments, the client device 102 is configured to communicate with other devices and/or entities via a communication application 110. Generally, the communication application 110 is representative of functionality to enable different forms of communication via the client device 102. Examples of the communication application 110 include a voice communication application (e.g., a Voice over Internet Protocol (VoIP) client), a video communication application, a messaging application, a content sharing application, a Unified Communications (UC) application, and combinations thereof. The communication application 110, for instance, enables different communication modalities to be combined to provide diverse communication scenarios.

The environment 100 further includes wireless infrastructure components 112, which are representative of components that implement wireless portions of network(s) 114. In at least some implementations, the wireless infrastructure components 112 may serve as gateways between wired and wireless portions of the network(s) 114. Examples of the wireless infrastructure components 112 include wireless base stations (e.g., wireless access points (WAPs)), routers, gateways, switches, and so forth. Included as part of the wireless infrastructure components 112 is a wireless base station 116, which is representative of an access point for the client device 102 to connect wirelessly to the network 114. The wireless base station 116 may be implemented in various ways, such as a wireless broadband access point, a wireless cellular base station, and so forth.

Generally, the network 114 is representative of a single network or a combination of different interconnected networks. In at least some implementations, the network 114 represents different portions of the radio spectrum that may be leveraged for wireless communication. The network 114, for instance, represents radio spectrum in different frequency bands, such as ultra-high frequency (UHF), super-high frequency (SHF), and so forth. The network 114 may also represent a combination of wireless and wired networks and may be configured in a variety of ways, such as a wide area network (WAN), a local area network (LAN), the Internet, and so forth.

According to various implementations, the client wireless module 104 is configured to perform various aspects of techniques for wireless signal quality indicator discussed herein. For instance, the client wireless module 104 may detect signal strength of wireless signal between the client device 102 and the wireless base station 116, and may detect errors in data communicated between the client device 102 and the wireless base station 116. The client wireless module 104 is configured to utilize such information (e.g., signal strength, data errors, and so forth) to characterize signal quality between the client device 102 and various entities connected to the network 114, such as the endpoints 120. Example ways in which the client wireless module 104 may ascertain and/or characterize wireless signal quality are detailed below.

The client device 102 further includes a web application 118, which is representative of an application that is configured to perform various tasks via connection to the network 114. The web application 118, for instance, can interact with various network-based entities to perform various tasks, such as presentation of web content, interaction with web-based resources, communication with other entities, and so forth. Examples of the web application 118 include a web browser, a web-enabled enterprise application, a web-enabled productivity application, and so forth.

The environment 100 further includes endpoints 120, which are representative of entities with which the client device 102 may exchange data via wireless data transmission. The endpoints 120, for instance, represent other end-user client devices with which the client device 102 may communicate. This is not intended to be limiting, however, and the endpoints 120 may be implemented as other network-connected entities, such as a web server, a cloud-based service, a content sharing service, and so forth.

The endpoints 120 include communication clients 122, which in at least some implementations represent different instances of the communication application 110. Communication between the client device 102 and the endpoints 120, for instance, may be facilitated via communication between the communication application 110 and the communication clients 122.

In at least some implementations, a communication service 124 is leveraged to manage communication between the client device 102 and the endpoints 120. The communication service 124, for instance, is representative of a network service that performs various tasks for management of communication between the client device 102 and the endpoints 120. For example, the communication service 124 can manage initiation, moderation, and termination of communication sessions between the communication application 110 and the communication clients 122.

The environment 100 further includes a quality service 126, which is representative of a network functionality to determine signal quality attributes for different communication paths across the network 114. The quality service 126, for instance, can use various types of error detection techniques to detect errors across different communication paths in the network 114, such as between the client device 102 and the different endpoints 120. Examples of different error detection techniques are detailed below. Based on detected errors, the quality service 126 can notify different entities concerning signal quality. For example, the quality service 126 can notify the client device 102 (e.g., the client wireless module 104) concerning signal quality between the client device 102 and different regions of the network 114, such as the endpoints 120. Example ways in which the quality service 126 may ascertain and/or characterize wireless signal quality are detailed below.

Thus, in at least some implementations, the client device 102 may conserve resources such as battery and processing bandwidth by leveraging the quality service 126 to perform signal quality measurement. Alternatively or additionally, signal quality information received from the quality service 126 may be aggregated with signal quality measurements generated by the client device 102 to generate more complex and/or comprehensive indications of signal quality.

In at least some implementations, the quality service 126 may be implemented and/or managed by the communication service 124. Alternatively, the quality service 126 may represent an independent service that provides signal quality information to a diverse array of entities.

According to various implementations, entities described herein may be discussed in both plural and singular forms. Accordingly, a reference to an entity in a singular form generally refers to an instance of the entity. For example, a reference to an endpoint 120 refers generally to an instance of the endpoints 120.

Having described an example environment in which the techniques described herein may operate, consider now a discussion of some example implementation scenarios for wireless signal quality indicator in accordance with one or more embodiments.

### Example Implementation Scenarios

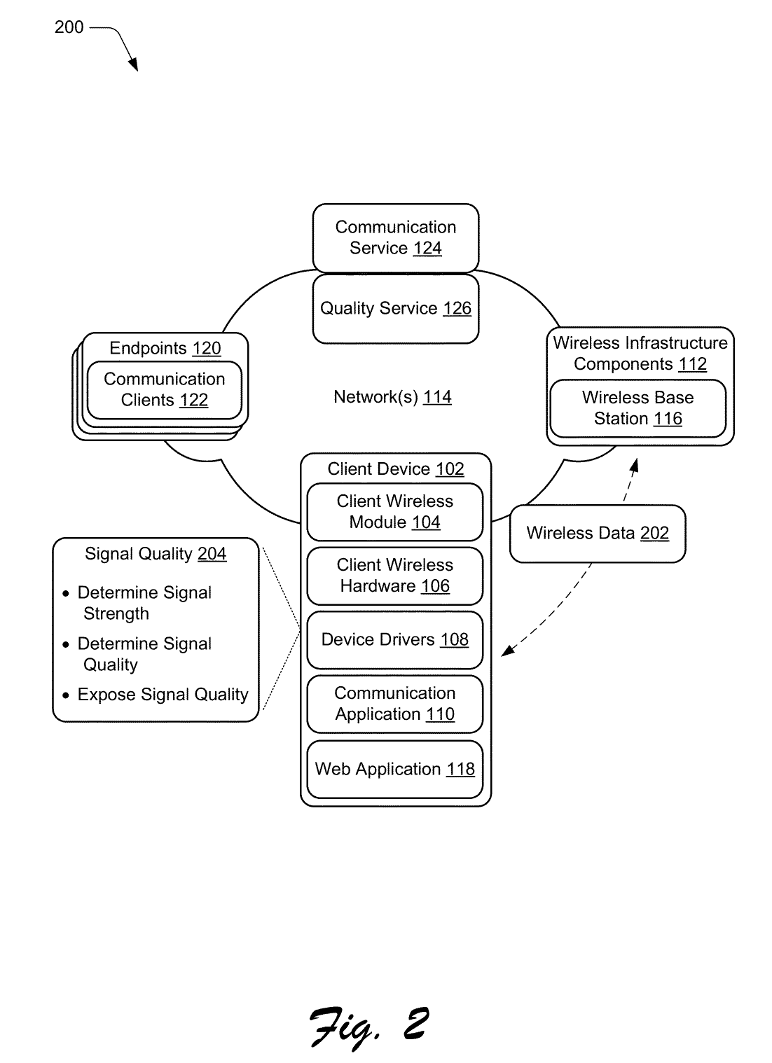

FIG. 2 illustrates an example implementation scenario 200 for techniques for wireless signal quality indicators in accordance with one or more implementations. While the scenario 200 is illustrated as being implemented in the environment 100 introduced above, it is to be appreciated that various aspects of the scenario 200 may be in any other suitable environment.

In the scenario 200, the client device 102 exchanges (e.g., transmits and receives) wireless data 202 via connection to the network 114. The client device 102, for instance, associates with the wireless base station 116, which provides the client device 102 with wireless connectivity to the network 114 to transmit and receive the wireless data 202. As referenced above, the wireless base station 116 may represent any type of infrastructure component that provides wireless connectivity, such as a wireless cellular base station, a wireless broadband access point (e.g., a WiFi™ AP), and so forth. The wireless data 202, for instance, may represent wireless cellular data, wireless broadband data, and/or combinations thereof.

The wireless data 202 may be implemented in various ways. For instance, the wireless data 202 may include communication data as part of a communication session between the client device 102 and an endpoint 120. Examples of such a communication session include a voice call (e.g., a wireless cellular call), voice data (e.g., VoIP data), video communication data, and combinations thereof. Alternatively or additionally, the wireless data 202 may include web content, such as web page content, web application 118 content, and so forth. Thus, the wireless data 202 generally represents any type of data that may be communicated wirelessly.

In at least some implementations, the wireless data 202 may be part of a communication session between the client device 102 and a communication endpoint 120. The wireless data 202, for instance, may be exchanged between the communication application 110 and a communication client 122. The communication service 124 may assist in exchange of the wireless data 202, such as by moderating and/or managing communication between the communication application 110 and a communication client 122.

In another example, the wireless data 202 may include “test data” that is used to determine attributes of data flow between the client device 102 and other entities connected to the network 114, such as a communication endpoint 120. The communication application 110, for instance, may submit test data to be transmitted to the communication endpoint 120 for purposes of determining end-to-end signal quality between the client device 102 and the communication endpoint 120.

Continuing with the scenario 200, the client device 102 ascertains signal quality 204 for the wireless data 202. For instance, the client wireless module 104 ascertains a signal strength value (e.g., an average value) for a wireless connection between the client device 102 and the wireless base station 116, e.g., an RSSI value for the wireless connection. The client wireless module 104 further detects errors that occur during exchange of the wireless data 202, examples of which are detailed elsewhere herein. The signal strength value is then adjusted based on the detected errors to generate the signal quality 204. Detailed ways of characterizing signal quality based on signal strength and detected signal errors are presented below.

According to various implementations, the signal quality 204 can be exposed in various ways. For instance, a visual representation of the signal quality 204 can be displayed on the client device 102. Additionally or alternatively, the signal quality 204 can be communicated to various entities to enable the entities to perform various actions based on the signal quality 204. Further details concerning how the signal quality 204 may be exposed are discussed below.

FIG. 3 illustrates an example implementation scenario 300 for wireless signal quality indicator in accordance with one or more implementations. While the scenario 300 is illustrated as being implemented in the environment 100 introduced above, it is to be appreciated that various aspects of the scenario 300 may be in any other suitable environment. The scenario 300 may represent an alternative or additional implementation scenario to the scenario 200 discussed above.

In the scenario 300, the quality service 126 detects signal quality 302 for communication of data 304 in different portions of the network 114. Example ways of ascertaining signal quality are discussed below. For instance, the quality service 126 detects signal quality for wireless connections between the client device 102 and one or more of the endpoints 120. Generally, the signal quality 302 pertains to end-to-end signal quality across wireless and wired portions of the network 114 for wireless communication of the data 304 and over different data routing paths.

The quality service 126 can detect the signal quality 302 in various ways. For instance, different entities connected to the network 114 can communicate various quality-related information concerning the data 304 to the quality service 126, such as signal strength information, quantity and/or rate of errors, bandwidth across different routing paths, and so forth. Examples of such entities that can communicate quality information include the client device 102, the endpoints 120, the network infrastructure components 112, and so forth. Thus, in at least some implementations, the quality service 126 can aggregate signal quality information from a variety of different entities.

Alternatively or additionally, the quality service 126 can implement various quality testing procedures to proactively determine signal quality across different portions of the network 114. For instance, the quality service 126 may cause the data 304 to be communicated to and/or between various entities connected to the network 114. The data 304, for example, may represent test data that replicates various data transmission scenarios, such as upload and/or download of network content, communication sessions between different devices, content streaming to different devices, and so forth.

According to various implementations, the quality service 126 may then gather signal quality information based on transmission of the data 304, such as a network bandwidth experienced during communication of the data 304, errors detected in the data 304, signal strength for the data 304 in different wireless portions of the test data communication path, and so forth. As discussed above, the signal quality information may be received from various entities connected to the network 114.

Continuing with the scenario 300, the quality service 126 communicates the signal quality 302 to the client device 102. In at least some implementations, the signal quality 302 can be communicated in response to a query from the client device 102 for signal quality information, such as a query for signal quality for a particular routing path across the network. Alternatively or additionally, the quality service 126 may proactively communication the signal quality 302 to the client device 102, e.g., independent of a query from the client device 102 for signal quality information. As further detailed below, the client device 102 may leverage the signal quality 302 in various ways, such as to notify a user of signal quality, notify an application of signal quality, to adapt wireless settings of the client device 102 based on the signal quality 302, and so forth.

Having discussed an example implementation scenario, consider now some example procedures in accordance with one or more implementations.

### Example Procedures

The following discussion describes some example procedures for wireless signal quality indicator in accordance with one or more embodiments. The example procedures may be employed in the environment 100 of FIG. 1, the system 1700 of FIG. 17, and/or any other suitable environment. The procedures, for instance, represent example procedures for implementation of the scenarios described above. In at least some implementations, the steps described for the various procedures can be implemented automatically and independent of user interaction. According to various implementations, the procedures may be performed by the client device 102, the quality service 126, and/or via interaction between the client device 102 and the quality service 126.

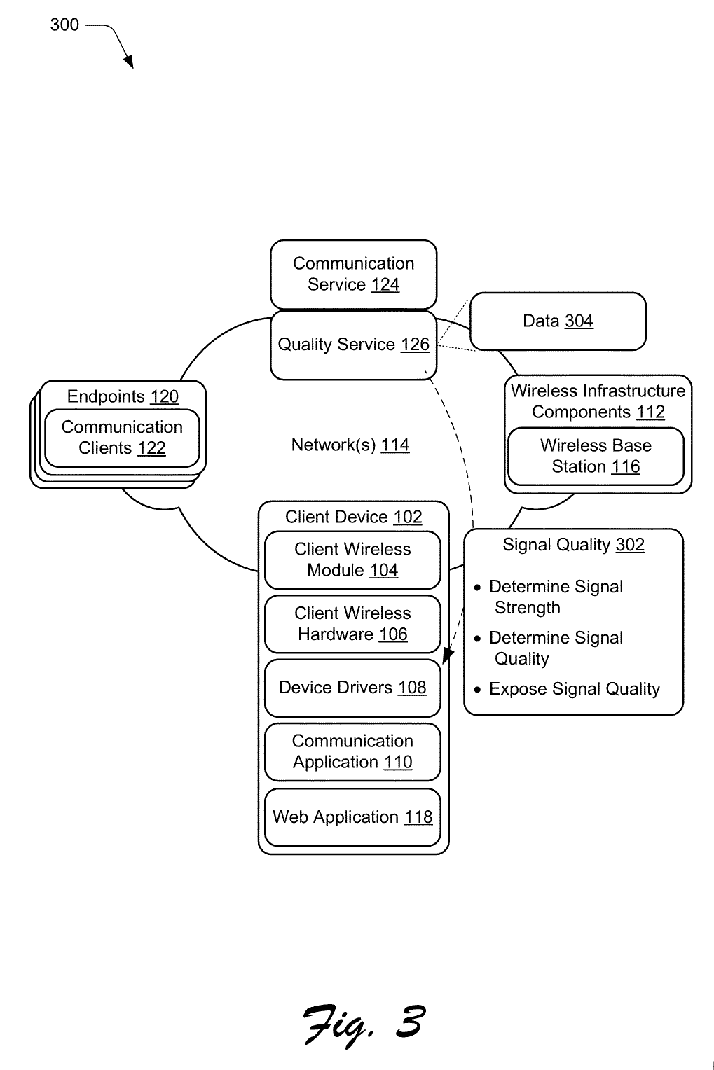

FIG. 4 is a flow diagram that describes steps in a method in accordance with one or more implementations. The method, for instance, describes an example procedure for generating a signal quality indicator in accordance with one or more implementations.

Step 400 determines a signal strength value for a wireless signal used to communicate data. The signal strength, for instance, corresponds to a signal strength for a wireless signal used to communicate data between a client device and a wireless base station. With reference to the scenario 200, for instance, the signal strength value corresponds to a signal strength of the connection between the client device 102 and the wireless base station 116 for exchange of the wireless data 202. The signal strength value may be determined in various ways, such as via an average RSSI value for the wireless signal, decibels per milliwatt (dBm), watts (W), and so on.

Generally, the data may take a variety of different forms. The data, for instance, may be communication data exchanged as part of a communication session (e.g., a real-time communication session) between the client device 102 and a communication endpoint 120. Alternatively or additionally, the data may include web content communicated to the client device 102, such as content of a web page. According to various implementations, the data may be communicated according to a variety of data communication protocols, such as Hypertext Transfer Protocol (HTTP), User Datagram Protocol (UDP), Transmission Control Protocol (TCP), and so forth.

Alternatively or additionally, the data may represent data exchanged via a wireless cellular network, such as via connection to a wireless cellular base station.

Step 402 detects errors in the data. The errors can be detected in various ways, examples of which are detailed below.

Step 404 adjusts the signal strength value based on the errors detected in the data to characterize a signal quality of the wireless signal. The signal strength value, for instance, is decreased based on an adjustment value that is calculated based on the errors, such as based on error rate, number of errors, and so forth. An example way of calculating an adjustment value based on errors is detailed below.

Alternatively or additionally, the signal strength value can be adjusted as a mathematical function of the detected errors. For instance, the signal strength value may be reduced as an inverse function of the detected errors such that an increase in detected errors causes a corresponding decrease in the signal strength value.

Step 406 outputs a signal quality indicator based on the adjusted signal strength value. Generally, the signal quality indicator provides an indication of a quality of data transmission that takes into consideration both wireless signal strength and errors detected in data exchanged via the wireless signal. In at least some implementations, the signal quality indicator is output to indicate a signal quality of the wireless signal relative to the signal strength of the wireless signal.

According to various implementations, the signal quality indicator may be output in various ways. For instance, a visual indication of the signal quality indicator may be displayed, such as on the client device 102. Example implementations for displaying signal quality indicators are discussed below.

Alternatively or additionally, the signal quality indicator may be output as a notification to various functionalities. For instance, the signal quality indicator may be output to an application involved in exchange of the data. With reference to a communication session, for example, a notification that includes the signal quality indicator may be communication to an application and/or service involved in the communication session, such as the communication application 110, the communication client 122, the communication service 124, and so forth. The application and/or service may perform various actions based on the notification, such as implementing measures to compensate for poor signal quality and/or the improve signal quality.

In at least some implementations, signal quality can be characterized based on detected errors and independent of signal strength. For instance, consider the following example procedure.

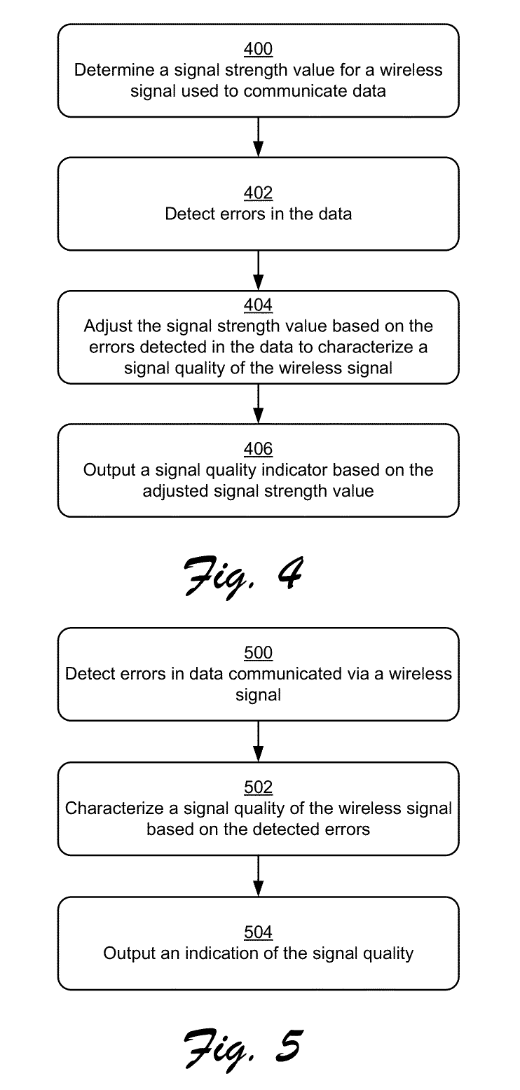

FIG. 5 is a flow diagram that describes steps in a method in accordance with one or more implementations. The method describes an example procedure for generating a signal quality indicator based on errors detected in wireless signal in accordance with one or more implementations.

Step 500 detects errors in data communicated via a wireless signal. In at least some implementations, the errors can be detected in data that is received, and/or based on data that is transmitted for receipt by another device. Example ways of detecting and quantifying errors in data are detailed below.

Step 502 characterizes a signal quality of the wireless signal based on the detected errors. The signal quality, for instance, is characterized based on various error-related conditions, example of which are discussed below. In at least some implementations, the signal quality is characterized based on the detected errors and independent of a detected signal strength, e.g., independent of an RSSI for the wireless signal. An example way of characterizing signal quality based on detected errors is discussed below.

Step 504 outputs an indication of the signal quality. The indication of signal quality can be output in various way, such as a visual indication, an audible indication, and so forth. Example indicia of signal quality are illustrated in the accompanying FIGS. that are discussed below.

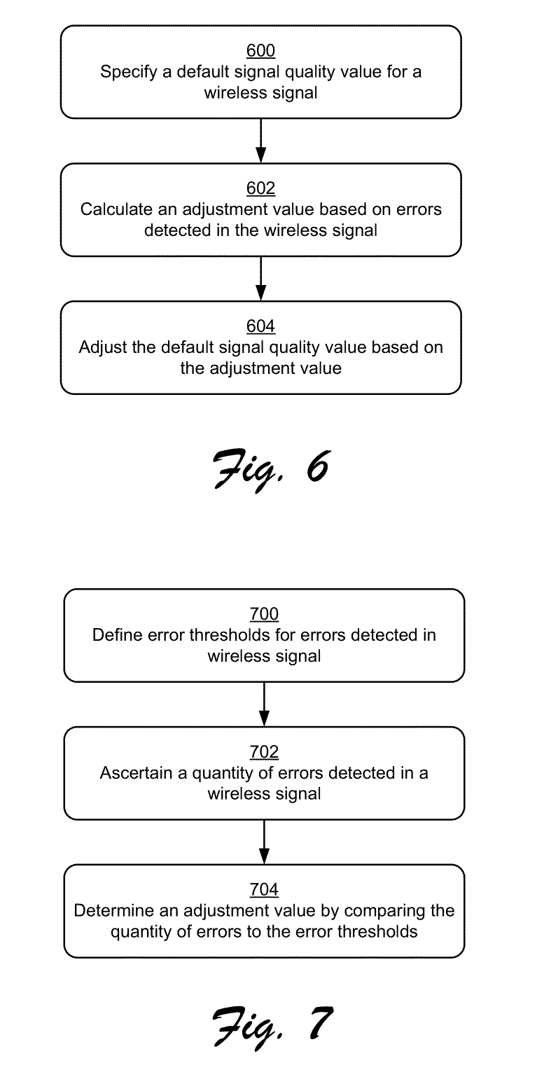

FIG. 6 is a flow diagram that describes steps in a method in accordance with one or more implementations. The method describes an example procedure for characterizing wireless signal quality based on errors detected in the wireless signal in accordance with one or more implementations.

Step 600 specifies a default signal quality value for a wireless signal. For instance, a default signal quality value can be specified that corresponds to a high quality wireless signal, e.g., a wireless signal in which few or no errors are detected.

Step 602 calculates an adjustment value based on errors detected in the wireless signal. The adjustment value, for instance, is calculated based on the errors detected in the wireless signal, such as based on error rate, number of errors, and so forth. An example way of calculating an adjustment value based on errors is detailed below.

Step 604 adjusts the default signal quality value based on the adjustment value. For instance, the default signal quality value is reduced based on the adjustment value, such as by subtracting the adjustment value from the default signal quality value to derive an adjusted signal quality value that characterizes the quality of the wireless signal.

Alternatively or additionally, the default signal quality value can be adjusted as a mathematical function of the adjustment value. For instance, the default signal quality value may be reduced as an inverse function of the adjustment value such that an increase in detected errors causes a corresponding decrease in the default signal quality value.

FIG. 7 is a flow diagram that describes steps in a method in accordance with one or more implementations. The method describes an example procedure for determining an adjustment value for adjusting a signal quality indicator in accordance with one or more implementations.

Step 700 defines error thresholds for errors detected in wireless signal. The error thresholds, for instance, each correspond to different quantities of errors detected in wireless signal, such as different bit error counts, different bit error rates, and so forth.

Step 702 ascertains a quantity of errors detected in a wireless signal. Examples ways of detecting and quantifying errors in wireless signal are detailed throughout this discussion. The errors, for instance, can be quantified as a number of errors detected over a particular period of time, as a bit error rate, and so forth.

Step 704 determines an adjustment value by comparing the quantity of errors to the error thresholds. For instance, a first error threshold may correspond to a range of zero to X number of errors, a second error threshold may correspond to Y number of errors, a third error threshold may correspond to Z number of errors, and so forth, with X, Y, Z representing different discrete error quantities, such as number of bit errors, bit error rates, and so forth. Further, the first error threshold may correspond to an adjustment value of zero (0), the second error threshold may correspond to an adjustment value of one (1), the third error threshold may correspond to an adjustment value of two (2), and so forth. For instance, if the quantity of errors is X or fewer, the adjustment value is determined to be zero (0). If the quantity of errors is at least X but less then Y, the adjustment value is one (1). If the quantity of errors is at least Y but less than Z, the adjustment value is two (2), and so on.

Thus, in at least some implementations, a set of error thresholds are defined such that as errors increase past respective thresholds, an adjustment value for adjusting a signal quality indicator increases. Correspondingly, as errors decrease past respective thresholds, an adjustment value decreases. Example ways for leveraging an adjustment value for characterizing wireless signal quality are detailed elsewhere herein.

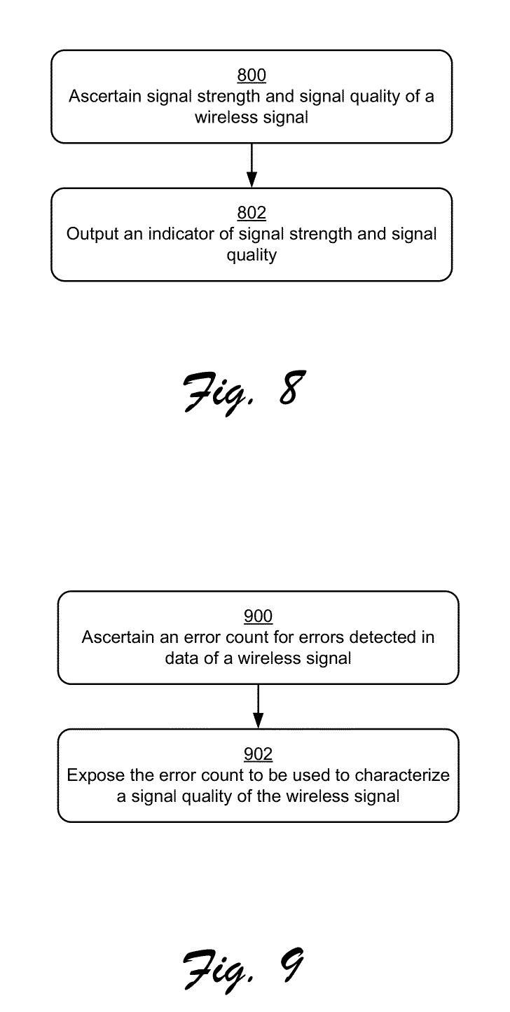

FIG. 8 is a flow diagram that describes steps in a method in accordance with one or more implementations. The method describes an example procedure for presenting indicia of signal strength and signal quality in accordance with one or more implementations.

Step 800 ascertains signal strength and signal quality of a wireless signal. Signal strength, for instance, corresponds to an RSSI for the wireless signal. According to various implementations, signal quality is ascertained based on errors detected in data that is communicated via the wireless signal and/or other indicia of signal quality. Example ways for characterizing signal quality are detailed elsewhere herein.

Step 802 outputs an indicator of signal strength and signal quality. The indicator, for instance, can be output as a combined representation of both signal strength and signal quality. Alternatively or additionally, the indicator can include separate indicia of signal strength and signal quality. According to various implementations, the indicator can be output in various ways, such as via display of a graphical indicator, an audible indicator, and so forth. Examples of indicators of signal strength and signal quality are discussed below.

Errors in wireless data can be detected and/or characterized in various ways. For instance, consider the following example procedures.

FIG. 9 is a flow diagram that describes steps in a method in accordance with one or more implementations. The method describes an example procedure for characterizing errors in wireless data in accordance with one or more implementations.

Step 900 ascertains an error count for errors detected in data of a wireless signal. The error count may be specified in various ways, such as a number of bit errors, a number of packet errors, and so forth. In at least some implementations, the error count may be ascertained as a number of errors over a discrete period of time, such as over 0.5 seconds, 1 second, 5 seconds, and so forth.

The error count can be ascertained in various ways. For instance, the error count can be determined based on output from a cyclical redundancy check (CRC) performed on the data. As the client device 102 receives the data, for example, the client device 102 can perform a CRC procedure on the data to detect errors. Output of the CRC indicates a number of errors detected, e.g., over a particular period of time.

As another example, error count can be based on errors detected based on error correction coding, such as forward error correction (FEC) performed on the data. Examples of FEC that may be applied to the data include hard-decision FEC, soft-decision FEC and so forth. Output from FEC of the data, for instance, specifies a number of errors detected and/or corrected in the data via FEC. For instance, data that is transmitted in a wireless signal can be encoded prior to transmission (e.g., using a block code, a convolution code, and so on) to enable a receiving device to determine whether errors are present in the data when it is received. Further, such encoding can enable a receiving device to quantify how many errors are present, such as a number of flipped bits, a number of omitted bits, and so on. Correction coding may also enable a receiving device to correct such errors.

In at least some implementations, multiple different types of encoding may be employed for data that is to be transmitted wirelessly. For instance, data may be encoded using FEC encoding, and the resulting FEC-encoded data may then be encoded using CRC encoding. A receiving device (e.g., the client device 102) can decode the data first using a CRC decoder, and then an FEC decoder. This can enable a receiving device to determine overall data integrity based on attempted CRC decoding, and to quantify and/or repair data errors via FEC decoding.

Step 902 exposes the error count to be used to characterize a signal quality of the wireless signal. The error count on its own, for instance, can be used to characterize a signal quality of the wireless signal. Alternatively or additionally, a signal strength value for the wireless signal can be adjusted based on the error count, such as discussed above. As yet another example implementation, the error count can be used to generate an adjustment value for adjusting an indicator of signal quality, such as discussed above with reference to FIGS. 4-7. In at least some implementations, the error count can be communicated to an application (e.g., the communication application 110 and/or the web application 118) to enable the application to perform various actions based on the error count.

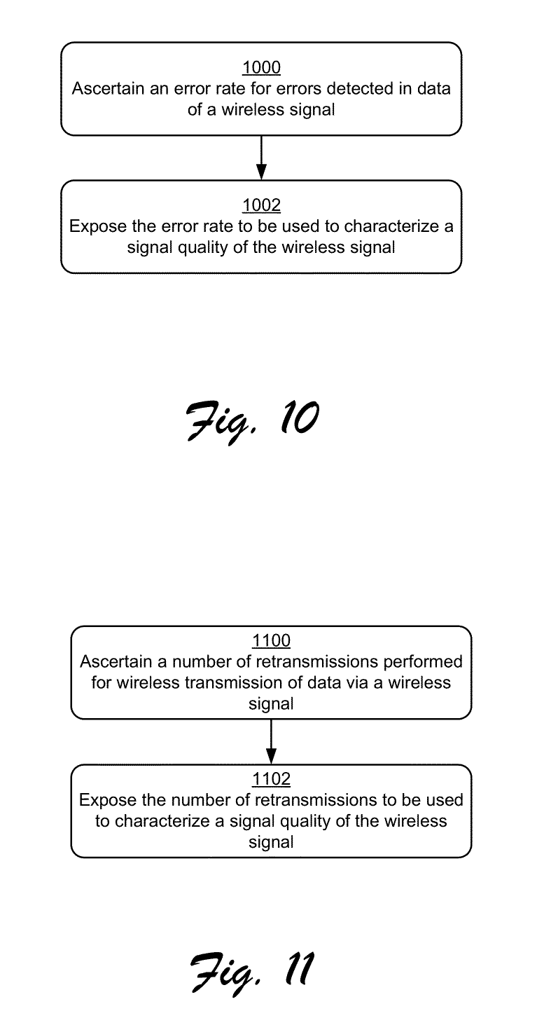

FIG. 10 is a flow diagram that describes steps in a method in accordance with one or more implementations. The method describes an example procedure for characterizing errors in wireless data in accordance with one or more implementations.

Step 1000 ascertains an error rate for errors detected in data of a wireless signal. The error rate, for instance, may be based on a number of errors detected over a period of time, such as bit error rate (BER), packet error rate (PER), and so forth. Error rate may be detected in various ways, such as based on errors detected via CRC performed on the data.

Step 1002 exposes the error rate to be used to characterize a signal quality of the wireless signal. The error rate on its own, for instance, can be used to characterize a signal quality of the wireless signal. Alternatively or additionally, a signal strength value for the wireless signal can be adjusted based on the error rate, such as discussed above. As yet another example implementation, the error rate can be used to generate an adjustment value for adjusting an indicator of signal quality, such as discussed above with reference to FIGS. 4-7. In at least some implementations, the error rate can be communicated to an application (e.g., the communication application 110 and/or the web application 118) to enable the application to perform various actions based on the error rate.

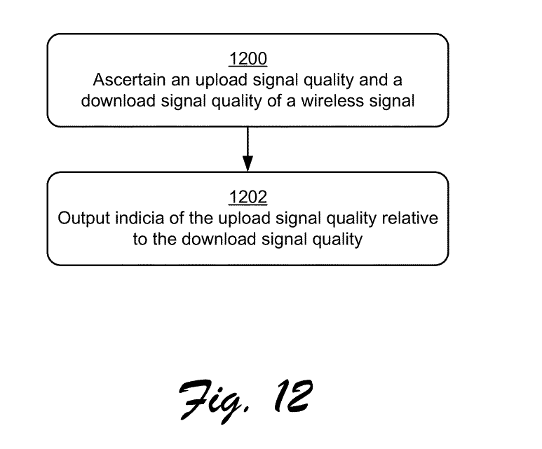

FIG. 11 is a flow diagram that describes steps in a method in accordance with one or more implementations. The method describes an example procedure for characterizing errors in data transmission in wireless data in accordance with one or more implementations.

Step 1100 ascertains a number of retransmissions performed for wireless transmission of data via a wireless signal. The retransmissions, for instance, are performed based on techniques for automatic repeat request (ARQ) that enable data transmission to be repeated when it is determined that data transmission failed, e.g., that data did not reach a recipient and/or that data was corrupted when received by a recipient.

The client device 102, for instance, may retransmit wireless data that is not acknowledged by a receiving device, such as based on data for which an acknowledgement (ACK) is not received within an ACK timeout period. According to various implementations, the client device 102 may track a number of retransmissions that occur during a particular data session and/or over a particular network connection and over a particular period of time.

Step 1102 exposes the number of retransmissions to be used to characterize a signal quality of the wireless signal. The number of retransmissions on its own, for instance, can be used to characterize a signal quality of the wireless signal. Alternatively or additionally, a signal strength value for the wireless signal can be adjusted based on the number of retransmissions. As yet another example implementation, the number of retransmissions can be used to generate an adjustment value for adjusting an indicator of signal quality, such as discussed above with reference to FIGS. 4-7. In at least some implementations, the number of retransmissions can be communicated to an application (e.g., the communication application 110 and/or the web application 118) to enable the application to perform various actions based on the error rate.

FIG. 12 is a flow diagram that describes steps in a method in accordance with one or more implementations. The method describes an example procedure for characterizing download signal quality and upload signal quality of a wireless signal in accordance with one or more implementations.

Step 1200 ascertains an upload signal quality and a download signal quality of a wireless signal. For instance, techniques discussed above for characterizing signal quality of a wireless signal can be applied to data that is downloaded to a device, and separately to data that is uploaded from the device. Thus, separate signal quality values can be determined for data that is downloaded and data that is uploaded.

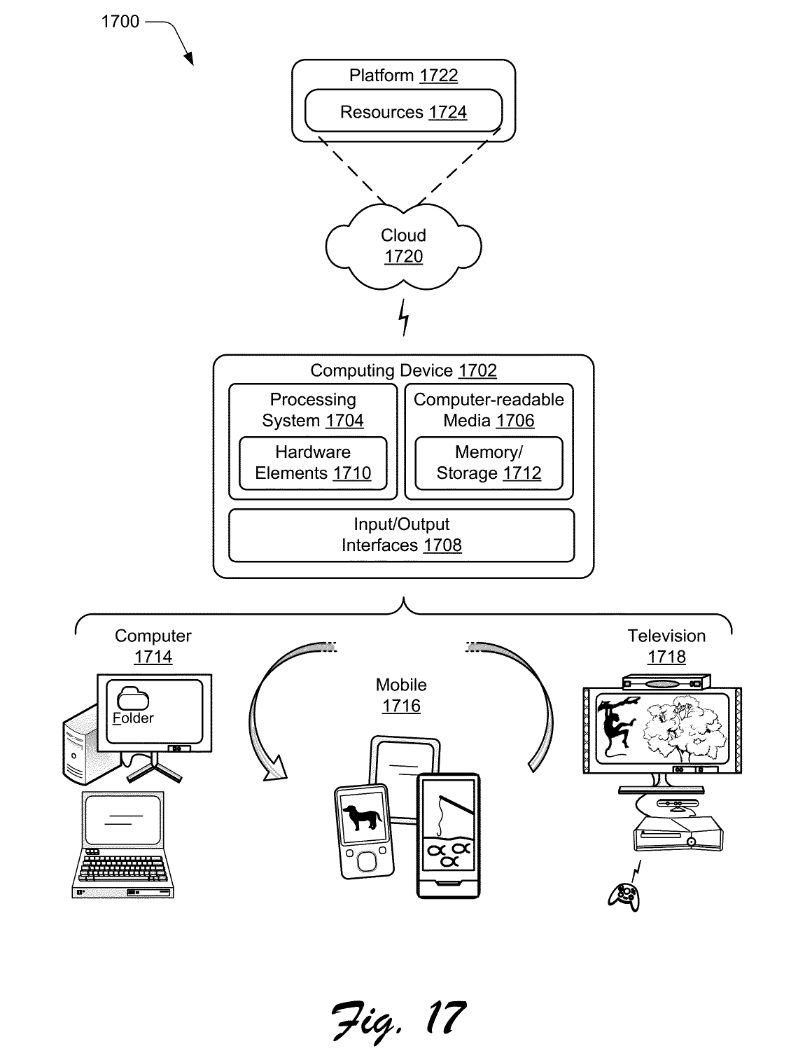

Step 1202 outputs indicia of the upload signal quality relative to the download signal quality. The indicia, for instance, contrast the upload signal quality with the download signal quality. The indicia may be output in various ways, such as via graphical indicia, audio indicia, and so forth. An example of such indicia is discussed below with reference to FIG. 16.

According to various implementations, the methods described above as well as other procedures described herein can be performed in real-time to provide a dynamic indication of signal quality. For instance, various procedures can respond to changes in signal quality characteristics to dynamically adjust indications of signal strength and signal quality.

Having discussed some example procedures, consider now a discussion of some example graphical indicators of signal attributes in accordance with one or more implementations.

Graphical Indicators of Signal Attributes

This section describes some example graphical indicators of signal attributes in accordance with one or more implementations. The described graphical indicators are not to be construed as limiting, and are presented for purpose of example only.

FIG. 13 illustrates a signal strength indicator 1300 in accordance with one or more implementations. The signal strength indicator 1300, for instance, represents a signal strength values ascertained in various ways, examples of which are discussed above.

The signal strength indicator 1300 includes strength bars 1302, which can be shaded and/or colored to indicate signal strength of a wireless signal. For instance, the more strength bars 1302 that are shaded and/or colored, the higher the signal strength of a wireless signal represented by the signal strength indicator 1300.

Adjacent to the signal strength indicator 1300 is a signal quality control 1304. According to various implementations, the signal quality control 1304 is displayed near and/or adjacent to the signal strength indicator 1300. This is not to be construed as limiting, however, and the signal quality control 1304 may be displayed separately and/or apart from the signal strength indicator 1300. The signal strength indicator 1300 and the signal quality control 1304 may be displayed in various ways, such as on a display screen of the client device 102, as part of a graphical user interface (GUI) of the communication application 110 and/or the web application 118, and so forth.

Generally, the signal quality control 1304 is selectable to cause an indicia of signal quality and/or other signal attributes to be presented. For instance, a user can select the signal quality control 1304 via any suitable input technique, examples of which are discussed below with reference to the system 1700. Selection of the signal quality control 1304, for example, causes the signal strength indicator 1300 to be replaced or augmented with an indicator of signal quality for a wireless signal characterized by the signal strength indicator 1300. For instance, consider the following example graphical indicators.

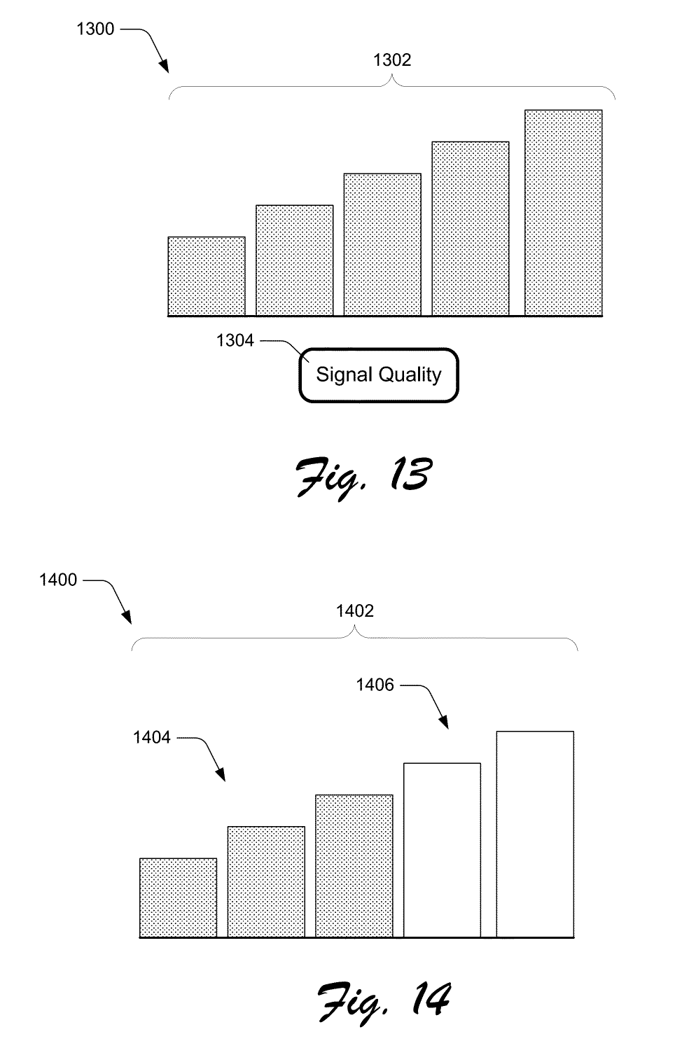

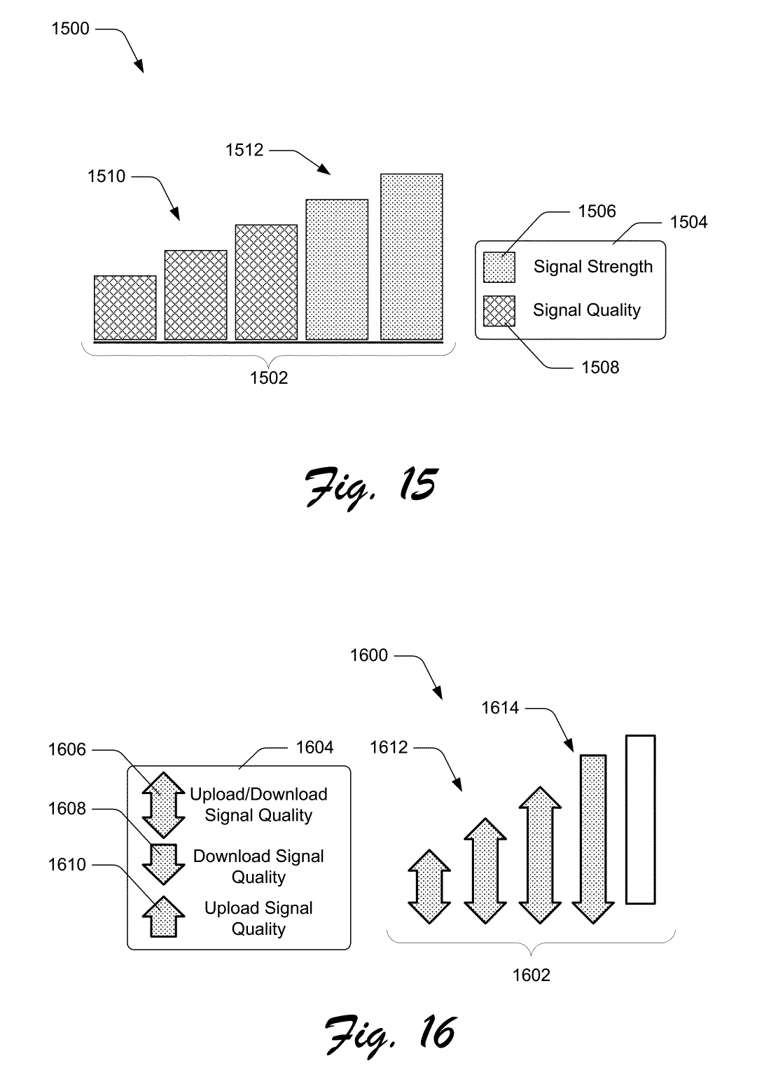

FIG. 14 illustrates an example signal quality indicator 1400 in accordance with one or more implementations. According to various implementations, the signal quality indicator 1400 represents a graphical indication of signal quality that is output according to techniques discussed above.

In at least some implementations, the signal quality indicator 1400 is output in response to a user selection of the signal quality control 1304 introduced above. This is not intended to be limiting, however, and the signal quality indicator 1400 may be output responsive to one or more of a variety of different events.

According to various implementations, the signal quality indicator 1400 represents a signal quality for a same wireless signal represented by the signal strength indicator 1300. For instance, the signal quality indicator 1400 represents an adjusted signal strength value, such that is adjusted according to techniques discussed above.

The signal quality indicator 1400 includes quality bars 1402, which in turn include shaded quality bars 1404 and non-shaded quality bars 1406. According to various implementations, the shaded quality bars 1404 can be distinguished from the non-shaded quality bars 1406 in various ways, such as based on differing shading levels, differing colors, differing fill patterns, and so forth. Generally, the more of the quality bars 1402 that are shaded, the higher the determined signal quality for a wireless signal. Accordingly, based on the presence of the non-shaded quality bars 1406, it can be seen that the signal strength represented by the signal strength indicator 1300 has been reduced to generate the signal quality indicator 1400.

According to various implementations, the signal quality indicator 1400 can replace the signal strength indicator 1300 in a display region. Alternatively, the signal quality indicator 1400 can be displayed along with the signal strength indicator 1300, such as in different regions of a display, adjacent to one another, and so forth.

FIG. 15 illustrates an example signal attributes indicator 1500 in accordance with one or more implementations. According to various implementations, the signal attributes indicator 1500 represents a graphical indication of signal quality and signal strength that is output according to techniques discussed above.

The signal attributes indicator 1500 includes attributes bars 1502, which can be shaded in various ways to convey attributes of a wireless signal, such as signal strength, signal quality, and so forth. Displayed adjacent to the signal attributes indicator 1500 is an attributes legend 1504, which provides interpretation information for deriving signal attributes from the signal attributes indicator 1500. The attributes legend 1504, for instance, indicates that attributes bars 1502 that include a shading 1506 indicate signal strength of a wireless signal, and attributes bars 1502 that include a shading 1508 indicate a signal quality of the wireless signal.

Accordingly, the attributes bars 1502 include attributes bars 1510 that are shaded according to the shading 1508, and attributes bars 1512 that are shaded according to the shading 1506. Thus, the attributes bars 1510 indicate a signal quality of a wireless signal relative to a signal strength of the wireless signal indicated by the attributes bars 1512. For instance, the attributes bars 1510 indicate that a quality of the wireless signal is less than a strength of the wireless signal.

According to various implementations, the larger attributes bars 1502 are shaded based on the signal attribute(s) with the highest value. For instance, if the signal quality of the wireless signal represented by the signal attributes indicator 1500 is greater than the signal strength, than shading of the attributes bars 1512 relative to the attributes bars 1510 may be reversed from the shading illustrated in FIG. 15.

Thus, the signal attributes indicator 1500 presents an example way of distinguishing different signal attributes from one another, such as for distinguishing signal strength of a wireless signal from signal quality of the wireless signal. Further, the signal attributes indicator 1500 presents an integrated visual representation such that different signal attributes may be combined in a single representation, thus simplifying user understanding and reducing screen space utilized to represent different signal attributes.

FIG. 16 illustrates an example signal quality indicator 1600 in accordance with one or more implementations. According to various implementations, the signal quality indicator 1600 represents a graphical indication of signal quality that is output according to techniques discussed above.

The signal quality indicator 1600 includes quality bars 1602, which can be shaded and/or shaped in different ways to indicate different signal quality attributes. Displayed adjacent to the quality bars 1602 is a quality legend 1604, which provides interpretation information for deriving signal quality information from the signal quality indicator 1600. The quality legend 1604, for instance, indicates that a quality bar 1602 that is configured as a double-sided shaded arrow 1606 indicates a relative combined upload and download signal quality of a wireless signal. The quality legend 1604 further indicates that a quality bar 1602 that is configured as a shaded down arrow 1608 indicates a relative download signal quality of a wireless signal. Still further, the quality legend 1604 indicates that a quality bar 1602 that is configured as a shaded up arrow 1610 indicates a relative upload signal quality of a wireless signal.

Accordingly, the quality bars 1602 include quality bars 1612 that are configured as the double-sided shaded arrow 1606, and thus indicate a relative upload and download signal quality of a wireless signal. The quality bars 1602 further include a quality bar 1614 that is configured as the shaded down arrow 1608, and thus indicates a relative download signal quality of the wireless signal. Generally, the larger quality bars 1602 indicate a higher relative quality than the smaller quality bars 1602. Thus, the quality indicator 1600 indicates that a particular wireless signal has a higher relative download signal quality as compared with an upload signal quality for the wireless signal.

Generally, the visual indicators presented above provide example ways of visually presenting information concerning attributes of wireless signal, such as signal strength, signal quality, and so forth. The visual indicators may be presented and combined in various ways to convey different types and combinations of signal attributes. Further, the visual indicators may be presented in response to various events, such as a user request for signal attributes (e.g., via selection of the signal quality control 1304), in response to changes in signal quality, in response to a user launching an application, and so forth.

Having discussed some example methods and implementation scenarios, consider now a discussion of an example system and device in accordance with one or more embodiments.

### Example System and Device

FIG. 17 illustrates an example system generally at 1700 that includes an example computing device 1702 that is representative of one or more computing systems and/or devices that may implement various techniques described herein. For example, the detection device 102 discussed above with reference to FIG. 1 can be embodied as the computing device 1702. The computing device 1702 may be, for example, a server of a service provider, a device associated with the client (e.g., a client device), an on-chip system, and/or any other suitable computing device, apparatus, and/or computing system.

The example computing device 1702 as illustrated includes a processing system 1704, one or more computer-readable media 1706, and one or more I/O Interfaces 1708 that are communicatively coupled, one to another. Although not shown, the computing device 1702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1704 is representative of functionality to perform one or more operations using hardware. Accordingly, the processing system 1704 is illustrated as including hardware element 1710 that may be configured as processors, functional blocks, and so forth. This may include implementation in hardware as an application specific integrated circuit or other logic device formed using one or more semiconductors. The hardware elements 1710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1706 is illustrated as including memory/storage 1712. The memory/storage 1712 represents memory/storage capacity associated with one or more computer-readable media. The memory/storage 1712 may include volatile media (such as random access memory (RAM)) and/or nonvolatile media (such as read only memory (ROM), Flash memory, optical disks, magnetic disks, and so forth). The memory/storage 1712 may include fixed media (e.g., RAM, ROM, a fixed hard drive, and so on) as well as removable media (e.g., Flash memory, a removable hard drive, an optical disc, and so forth). The computer-readable media 1706 may be configured in a variety of other ways as further described below.

Input/output interface(s) 1708 are representative of functionality to allow a user to enter commands and information to computing device 1702, and also allow information to be presented to the user and/or other components or devices using various input/output devices. Examples of input devices include a keyboard, a cursor control device (e.g., a mouse), a microphone (e.g., for implementing voice and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1702. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1710. The computing device 1702 may be configured to implement particular instructions and/or functions corresponding to the software and/or hardware modules. Accordingly, implementation of modules as an module that is executable by the computing device 1702 as software may be achieved at least partially in hardware, e.g., through use of computer-readable storage media and/or hardware elements 1710 of the processing system. The instructions and/or functions may be executable/operable by one or more articles of manufacture (for example, one or more computing devices 1702 and/or processing systems 1704) to implement techniques, modules, and examples described herein.

As further illustrated in FIG. 17, the example system 1700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1702 may assume a variety of different configurations, such as for computer 1714, mobile 1716, and television 1718 uses. Each of these configurations includes devices that may have generally different constructs and capabilities, and thus the computing device 1702 may be configured according to one or more of the different device classes. For instance, the computing device 1702 may be implemented as the computer 1714 class of a device that includes a personal computer, desktop computer, a multi-screen computer, laptop computer, netbook, and so on.

The computing device 1702 may also be implemented as the mobile 1716 class of device that includes mobile devices, such as a mobile phone, portable music player, portable gaming device, a tablet computer, a multi-screen computer, and so on. The computing device 1702 may also be implemented as the television 1718 class of device that includes devices having or connected to generally larger screens in casual viewing environments. These devices include televisions, set-top boxes, gaming consoles, and so on.

The techniques described herein may be supported by these various configurations of the computing device 1702 and are not limited to the specific examples of the techniques described herein. For example, functionalities discussed with reference to the client device 102 and/or the quality service 126 may be implemented all or in part through use of a distributed system, such as over a “cloud” 1720 via a platform 1722 as described below.

The cloud 1720 includes and/or is representative of a platform 1722 for resources 1724. The platform 1722 abstracts underlying functionality of hardware (e.g., servers) and software resources of the cloud 1720. The resources 1724 may include applications and/or data that can be utilized while computer processing is executed on servers that are remote from the computing device 1702. Resources 1724 can also include services provided over the Internet and/or through a subscriber network, such as a cellular or Wi-Fi™ network.

The platform 1722 may abstract resources and functions to connect the computing device 1702 with other computing devices. The platform 1722 may also serve to abstract scaling of resources to provide a corresponding level of scale to encountered demand for the resources 1724 that are implemented via the platform 1722. Accordingly, in an interconnected device embodiment, implementation of functionality described herein may be distributed throughout the system 1700. For example, the functionality may be implemented in part on the computing device 1702 as well as via the platform 1722 that abstracts the functionality of the cloud 1720.

Discussed herein are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include a system comprising: at least one processor; and one or more computer-readable storage media including instructions stored thereon that, responsive to execution by the at least one processor, cause the system perform operations including: determining a signal strength value for a wireless signal used to communicate data between a client device and a wireless base station; detecting errors in the data; adjusting the signal strength value based on the errors detected in the data to characterize a signal quality of the wireless signal; and outputting a signal quality indicator based on the adjusted signal strength value including a graphical indication of the signal quality.

Implementations discussed herein include a system as described above, wherein the signal strength value comprises a received signal strength indicator (RSSI) value for the wireless signal, and wherein said adjusting comprises reducing the RSSI value based on the errors.

Implementations discussed herein include a system as described above, wherein the errors are detected via a cyclical redundancy check (CRC) performed on the data, and wherein the signal strength value is reduced based on the number of detected CRC errors.

Implementations discussed herein include a system as described above, wherein the errors are detected via forward error correction (FEC) performed on the data, and wherein the signal strength value is reduced based on the number of detected FEC errors.

Implementations discussed herein include a system as described above, wherein the errors comprise one or more of soft forward error correction (FEC) errors or hard FEC errors detected via FEC.

Implementations discussed herein include a system as described above, wherein the errors are detected based on a number of retransmissions detected for transmission of the data, and wherein the signal strength value is reduced based on the number of detected retransmissions.

Implementations discussed herein include a system as described above, wherein said outputting comprises adjusting a visual indication of the signal strength value to generate the graphical indication of the signal quality.

Implementations discussed herein include a system as described above, wherein said outputting includes a notification of the signal quality from a network-based service to a client device.

Implementations discussed herein include a system as described above, wherein the operations further include outputting a signal strength indicator that distinguishes the signal strength value from the signal quality.

Implementations discussed herein include a system as described above, wherein the operations further include: ascertaining an upload signal quality and a download signal quality for the data communicated via the wireless signal; and outputting indicia of the upload signal quality relative to the download signal quality.

Implementations discussed herein include a system as described above, wherein said adjusting the signal strength value comprises reducing the signal strength value based on an adjustment value calculated based on the errors detected in the data.

Implementations discussed herein include a system as described above, wherein the adjustment value is calculated by: ascertaining a quantity of the errors detected in the data; and determining the adjustment value by comparing the quantity of errors to one or more error thresholds defined for different quantities of errors detected in wireless signal.

Implementations discussed herein include a method comprising: determining a signal strength value for a wireless signal used to communicate data between a client device and a wireless base station; adjusting the signal strength value based on errors detected in the data; and outputting a signal quality indicator based on the adjusted signal strength value and a signal strength indicator based on the signal strength value, the signal quality indicator indicating a signal quality value of the wireless signal relative to the signal strength value of the wireless signal.

Implementations discussed herein include a method as described above, wherein the errors are detected via one or more of a cyclical redundancy check (CRC) performed on the data, or forward error correction (FEC) decoding performed on the data.

Implementations discussed herein include a method as described above, wherein the errors are detected based on a number of retransmissions of at least some of the data.

Implementations discussed herein include a method as described above, wherein the signal quality indicator indicates that the signal quality value is different than the signal strength value.

Implementations discussed herein include a method as described above, wherein said adjusting and said outputting are performed responsive to receiving an indication of a user selection of a selectable control for outputting the signal quality indicator.

Implementations discussed herein include a method comprising: detecting errors in data communicated via a wireless signal; characterizing a signal quality of the wireless signal based on the detected errors and independent of a signal strength of the wireless signal; and outputting an indication of the signal quality.

Implementations discussed herein include a method as described above, wherein said characterizing comprises: calculating an adjustment value based on the errors detected in the wireless signal; and adjusting a default signal quality value based on the adjustment value to obtain a signal quality value that indicates the signal quality of the wireless signal.

Implementations discussed herein include a method as described above, wherein said characterizing comprises characterizing a separate download signal quality and upload signal quality of the wireless signal, and wherein the indication of the signal quality includes separate indicators for the download signal quality and the upload signal quality.

### CONCLUSION

Techniques for wireless signal quality indicator are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

1. A system comprising:
at least one processor; and
one or more computer-readable storage media including instructions stored thereon that, responsive to execution by the at least one processor, cause the system perform operations including:
determining a signal strength value for a wireless signal used to communicate data between a client device and a wireless base station;
detecting errors in the data;
adjusting the signal strength value based on the errors detected in the data to characterize a signal quality of the wireless signal;
ascertaining an upload signal quality and a download signal quality for the data communicated via the wireless signal; and
outputting a signal quality indicator based on the adjusted signal strength value including a graphical indication of the signal quality and which indicates the upload signal quality relative to the download signal quality.

2. A system as recited in claim 1, wherein the signal strength value comprises a received signal strength indicator (RSSI) value for the wireless signal, and wherein said adjusting comprises reducing the RSSI value based on the errors.

3. A system as described in claim 1, wherein the errors are detected via a cyclical redundancy check (CRC) performed on the data, and wherein the signal strength value is reduced based on the number of detected CRC errors.

4. A system as described in claim 1, wherein the errors are detected via forward error correction (FEC) performed on the data, and wherein the signal strength value is reduced based on the number of detected FEC errors.

5. A system as described in claim 1, wherein the errors comprise one or more of soft forward error correction (FEC) errors or hard FEC errors detected via FEC.

6. A system as described in claim 1, wherein the errors are detected based on a number of retransmissions detected for transmission of the data, and wherein the signal strength value is reduced based on the number of detected retransmissions.

7. A system as described in claim 1, wherein said outputting comprises adjusting a visual indication of the signal strength value to generate the graphical indication of the signal quality.

8. A system as described in claim 1, wherein said outputting includes a notification of the signal quality from a network-based service to a client device.

9. A system as described in claim 1, wherein the operations further include outputting a signal strength indicator that distinguishes the signal strength value from the signal quality.

10. (canceled)

11. A system as described in claim 1, wherein said adjusting the signal strength value comprises reducing the signal strength value based on an adjustment value calculated based on the errors detected in the data.

12. A system as described in claim 11, wherein the adjustment value is calculated by:
ascertaining a quantity of the errors detected in the data; and
determining the adjustment value by comparing the quantity of errors to one or more error thresholds defined for different quantities of errors detected in wireless signal.

13. A computer-implemented method comprising:
determining a signal strength value for a wireless signal used to communicate data between a client device and a wireless base station;
adjusting the signal strength value based on errors detected in the data; and
outputting a signal quality indicator based on the adjusted signal strength value and a signal strength indicator based on the signal strength value, the signal quality indicator visually indicating a signal quality value of the wireless signal relative to the signal strength value of the wireless signal.

14. A computer-implemented method as recited in claim 13, wherein the errors are detected via one or more of a cyclical redundancy check (CRC) performed on the data, or forward error correction (FEC) decoding performed on the data.

15. A computer-implemented method as recited in claim 13, wherein the errors are detected based on a number of retransmissions of at least some of the data.

16. A computer-implemented method as recited in claim 13, wherein the signal quality indicator indicates that the signal quality value is different than the signal strength value.

17. A computer-implemented method as recited in claim 13, wherein said adjusting and said outputting are performed responsive to receiving an indication of a user selection of a selectable control for outputting the signal quality indicator.

18. A computer-implemented method comprising:
detecting errors in data communicated via a wireless signal;
characterizing a signal quality of the wireless signal based on the detected errors and independent of a signal strength of the wireless signal; and
outputting an indication of the signal quality.

19. A computer-implemented method as described in claim 18, wherein said characterizing comprises:
calculating an adjustment value based on the errors detected in the wireless signal; and
adjusting a default signal quality value based on the adjustment value to obtain a signal quality value that indicates the signal quality of the wireless signal.

20. A computer-implemented method as described in claim 18, wherein said characterizing comprises characterizing a separate download signal quality and upload signal quality of the wireless signal, and wherein the indication of the signal quality includes separate indicators for the download signal quality and the upload signal quality.

21. A system as described in claim 1, wherein the indicia of the upload signal quality relative to the download signal quality includes separate indicators for the upload signal quality and the download signal quality.
